(19) United States
(12) Patent Application Publication
(10) Pub. No.: US 2023/0409040 A1
(43) Pub. Date: Dec. 21, 2023

(54) Method for Controlling of Obstacle Avoidance according to Classification of Obstacle based on TOF camera and Cleaning Robot

(71) Applicant: AMICRO SEMICONDUCTOR CO., LTD., Zhuhai, Guangdong (CN)

(72) Inventors: Jianfeng DAI, Zhuhai, Guangdong (CN); Qinwei LAI, Zhuhai, Guangdong (CN); Gangjun XIAO, Zhuhai, Guangdong (CN)

(21) Appl. No.: 18/034,783

(22) PCT Filed: Sep. 24, 2021
(86) PCT No.: PCT/CN2021/120082

§ 371 Date: May 1, 2023

(30) Foreign Application Priority Data
Nov. 25, 2020 (CN) 202011336273.5

(51) Int. Cl. G05D 1/02

(52) U.S. Cl. CPC G05D 1/024; G05D 1/0242; G05D 1/0214; G05D 2201/0203

(57) ABSTRACT

A method for controlling of obstacle avoidance according to classification of obstacle based on time-of-flight (TOF) camera and cleaning robot are disclosed. The method includes: step 1: a longitudinal height of a target obstacle is calculated and obtained by combining a depth of the target obstacle collected by a TOF camera and intrinsic parameters and extrinsic parameters of the TOF camera, and the target obstacle is identified and classified into a wall-type obstacle, a toy-type obstacle, a doorsill-type obstacle, a sofa-type obstacle or an electric-wire-type obstacle on a basis of a data stability statistical algorithm; and step 2: a deceleration and obstacle avoidance mode or a deceleration and obstacle bypassing mode of a robot is decided according to a classification result, the longitudinal height of the target obstacle of a corresponding type and a trigger situation of a collision warning signal.

### TECHNICAL FIELD

The disclosure relates to the technical field of obstacle avoidance of intelligent robots, and particularly to a method for controlling of obstacle avoidance according to a classification of an obstacle based on a time-of-flight (TOF) camera and a cleaning robot.

### BACKGROUND

Currently, simultaneous localization and mapping (SLAM) robots based on inertial navigation, vision and lasers are becoming increasingly popular. Representatively, a household sweeping and cleaning robot implements real-time localization and mapping in an indoor environment by combining vision, a laser, a gyroscope, acceleration and data from a wheel odometer, and then implements localization and navigation according to an established map. However, the current difficulty of the robot lies in a complex obstacle environment. Since movable obstacles such as toys and electric wires are often left on the ground, the robot will push the obstacles or get entangled by the obstacles such as electric wires when colliding with the obstacles. Obstacles of sofa type are common in a home environment, in a case that a height under the sofa is just lower than that a top of the robot, the robot will possibly get stuck when entering. For the sake of saving cost, a single-line laser is employed in a current sweeping robot, which fails to detect such obstacles. Moreover, a single camera generally functions as a vision device, which fails to predict distance information in advance. As a result, it is impossible to detect obstacles in advance, even classify the obstacles. Chinese patent CN 110622085 A, published on Dec. 27, 2019, relates to obtain depth images of obstacles with at least one photographing device. However, controlling the robot to effectively avoid or bypass the obstacles according to different height passing conditions of the same type of obstacles before approaching the obstacles has not been described yet.

### SUMMARY

The specific technical solution is as follows: a method for controlling of obstacle avoidance according to a classification of an obstacle based on a time-of-flight (TOF)camera includes: step 1: longitudinal height of a target obstacle is calculated and obtained by combining depth information of the target obstacle collected by the TOF camera and intrinsic parameters and extrinsic parameters of the TOF camera, and the target obstacle is identified and classified into a wall-type obstacle, a toy-type obstacle, a doorsill-type obstacle, a sofa-type obstacle or an electric-wire-type obstacle on a basis of a data stability statistical algorithm; and step 2: a deceleration and obstacle avoidance mode or a deceleration and obstacle bypassing mode of a robot is decided according to a current traveling mode, a classification result, the longitudinal height of the target obstacle of a corresponding type and a trigger situation of a collision warning signal such that the robot preferentially enter an infrared obstacle avoidance mode in a trigger state of the collision warning signal; and an executive body of the method for controlling of obstacle avoidance according to the classification of the obstacle is the robot provided with the TOF camera and an infrared sensor at a front end of a robot body, and the target obstacle is in a current field-of-view area of the TOF camera; and the robot in the infrared obstacle avoidance mode avoids an obstacle detected in a current traveling direction on a basis of detection information of the infrared sensor.

Further, the step 2 includes: under a condition that the robot currently executes [symbol] -shaped traveling, the robot is controlled to travel in a decelerating manner in the current traveling direction after the target obstacle is classified into the toy-type obstacle and the longitudinal height of the target obstacle which is obtained by calculating is greater than a first preset toy height, simultaneously whether the robot triggers the collision warning signal is determined, in a case that yes, the robot is controlled to stop executing traveling in the decelerating manner in the current traveling direction, and avoid the obstacle detected in the current traveling direction on the basis of the detection information of the infrared sensor, and in a case that not, the obstacle detected in the current traveling direction is avoided on the basis of the detection information of the infrared sensor; and under a condition that the robot currently executes global edge-following traveling, the robot is controlled to travel in the decelerating manner in a current edge-following direction after the target obstacle is classified into the toy-type obstacle and the longitudinal height of the target obstacle which is obtained by calculating is greater than the first preset toy height, simultaneously whether the robot triggers the collision warning signal is determined, in a case that yes, the robot is controlled to stop traveling executing in the decelerating manner in the current traveling direction, and avoid the obstacle detected in the current traveling direction on the basis of the detection information of the infrared sensor, and in a case that not, the obstacle detected in the current traveling direction is avoided on the basis of the detection information of the infrared sensor; and in a process that the robot executes the [symbol] -shaped traveling or the global edge-following traveling, the infrared sensor on the robot detects the obstacle in real time.

Further, the step 2 further includes: under the condition that the robot currently executes the [symbol] -shaped traveling, the robot is controlled to travel in the decelerating manner after the target obstacle is classified into the toy-type obstacle and the longitudinal height of the target obstacle which is obtained by calculating is less than the first preset toy height, simultaneously whether the robot triggers the collision warning signal is determined, in a case that yes, the robot is controlled to stop traveling in the decelerating manner, and avoid the obstacle detected in the current traveling direction on the basis of the detection information of the infrared sensor, and in a case that not, when a depth distance between the robot and the target obstacle is a first toy safety distance, the robot is controlled to rotate by 90° in a first preset clockwise direction, move forward by a first preset distance, rotate by 90° in the first preset clockwise direction, and move forward, so as to implement right-angle turning; and under the condition that the robot currently executes the global edge-following traveling, the robot is controlled to travel in the decelerating manner after the target obstacle is classified into the toy-type obstacle and the longitudinal height of the target obstacle which is obtained by calculating is less than the first preset toy height, simultaneously whether the robot triggers the collision warning signal is determined, in a case that yes, the robot is controlled to stop traveling in the decelerating manner, and avoid the obstacle detected in the current traveling direction on the basis of the detection information of the infrared sensor, and in a case that not, when a depth distance between the robot and the target obstacle equals a second toy safety distance, the robot is controlled to rotate by 90° in a second preset clockwise direction, move forward by a second preset distance, rotate by 90° in a reverse direction of the second preset clockwise direction, and move forward by a third preset distance, whether other obstacles are present on an original global edge-following traveling path is detected by rotating by a first observation angle, in a case that yes, the detected obstacle is bypassed by first preset moving radian in an obstacle-bypassing traveling mode, and returned to the original global edge-following path, and in a cast that not, the target obstacle is bypassed by second preset moving radian, and returned to the original global edge-following path; and the first preset distance, the second preset distance and the third preset distance are all related to a contour width of the target obstacle collected by the TOF camera, and the contour width is a horizontal distance between a leftmost side and a rightmost side of the target obstacle in an overlapping region of an angle of view of the TOF camera and an effective distance measurement range; and the first toy safety distance is related to the depth information measured in a process that the robot executes the [symbol] -shaped traveling; and the second toy safety distance is related to the depth information measured in a process that the robot executes the global edge-following traveling.

Further, the first preset toy height is set as 65 mm; and the toy-type obstacle includes an island-type obstacle. Height features of the small parts configured in an actual furniture environment are satisfied, such that the obstacle forbidden to be touched is effectively detected and identified.

Further, the step 2 further includes: under a condition that the robot currently executes [symbol] -shaped traveling, the robot is controlled to travel in a decelerating manner after the target obstacle is classified into the doorsill-type obstacle, simultaneously whether the robot triggers the collision warning signal is determined, in a case that yes, the [symbol] -shaped traveling is stopped to execute, and the obstacle detected in the current traveling direction is avoided on the basis of the detection information of the infrared sensor, and in a case that not, the robot is controlled to keep traveling in the decelerating manner to pass over a doorsill; and under a condition that the robot currently executes global edge-following traveling, the robot is controlled to travel in the decelerating manner to pass over the doorsill after the target obstacle is classified into the doorsill-type obstacle, simultaneously whether the robot triggers the collision warning signal is determined, in a case that yes, the [symbol] -shaped traveling is stopped to execute, and the obstacle detected in the current traveling direction is avoided on the basis of the detection information of the infrared sensor, and in a case that not, the robot is controlled to keep traveling in the decelerating manner to pass over the doorsill; and the doorsill-type obstacle includes an obstacle for the robot to pass over. According to the technical solution, after the doorsill is identified, the robot moves forward in the decelerating manner to pass over the doorsill, so as to prevent the robot from impacting the doorsill at a high speed, thereby protecting the doorsill.

Further, the step 2 further includes: under a condition that the robot currently executes [symbol] -shaped traveling, the robot is controlled to keep executing an original [symbol] -shaped traveling after the target obstacle is classified into the wall-type obstacle, and simultaneously whether the robot triggers the collision warning signal is determined, in a case that yes, the [symbol] -shaped traveling is stopped to execute, and the obstacle detected in the current traveling direction is avoided on the basis of the detection information of the infrared sensor, and in a case that not, the obstacle detected in the current traveling direction is avoided on the basis of the detection information of the infrared sensor; and under a condition that the robot currently executes global edge-following traveling, the robot is controlled to keep an original edge-following traveling mode, and simultaneously whether the robot triggers the collision warning signal is determined, in a case that yes, the edge-following traveling is stopped to execute, and the obstacle detected in the current traveling direction is avoided on the basis of the detection information of the infrared sensor, and in a case that not, the original edge-following traveling mode is kept to execute.

Further, the step 2 further includes: under a condition that a traveling mode currently executed by the robot is [symbol] -shaped traveling, the deceleration and obstacle avoidance modes as follows: under a condition that the target obstacle is classified into the sofa-type obstacle and the longitudinal height of the target obstacle which is obtained calculating is less than a first preset sofa height, the robot is controlled to keep an original [symbol] -shaped traveling mode, simultaneously whether the robot triggers the collision warning signal is determined, in a case that yes, the original [symbol] -shaped traveling is stopped to execute, and the obstacle detected in the current traveling direction is avoided on the basis of the detection information of the infrared sensor, and in a case that not, the obstacle detected in the current traveling direction is avoided on the basis of the detection information of the infrared sensor, and the obstacle includes the target obstacle; under a condition that the target obstacle is classified into the sofa-type obstacle and the longitudinal height of the target obstacle which is obtained by calculating is greater than the first preset sofa height and less than a second preset sofa height, the robot is controlled to travel in a decelerating manner in the current traveling direction, simultaneously whether the robot triggers the collision warning signal is determined, in a case that yes, the robot is controlled to stop traveling in the decelerating manner in the current traveling direction, and the obstacle detected in the current traveling direction is avoided on the basis of the detection information of the infrared sensor, and in a case that not, the obstacle detected in the current traveling direction is avoided on the basis of the detection information of the infrared sensor; and under a condition that the target obstacle is classified into the sofa-type obstacle and the longitudinal height of the target obstacle which is obtained by calculating is greater than the second preset sofa height, the robot is controlled to enter a bottom of the sofa-type obstacle in a current [symbol] -shaped path, simultaneously whether the robot triggers the collision warning signal is determined, in a case that yes, the robot is controlled to stop entering the bottom of the sofa-type obstacle in the current [symbol] -shaped path, and other obstacles detected in the current traveling direction is avoided on the basis of the detection information of the infrared sensor, and in a case that not, the original [symbol] -shaped traveling mode is kept; and the second preset sofa height is greater than the robot body height of the robot; other obstacles are obstacles other than the sofa-type obstacle; and the sofa-type obstacle includes furniture for the robot to pass through.

Further, the step 2 further includes: under a condition that a traveling mode currently executed by the robot is global edge-following traveling, deceleration and obstacle avoidance modes as follows: under a condition that the target obstacle is classified into the sofa-type obstacle and the longitudinal height of the target obstacle which is obtained by calculating is less than a third preset sofa height, the robot is controlled to travel in a decelerating manner along a contour of the target obstacle, such that the robot does not get stuck by the target obstacle when colliding with the target obstacle; and under a condition that the target obstacle is classified into the sofa-type obstacle and the longitudinal height of the target obstacle which is obtained by calculating is greater than the third preset sofa height, the robot is controlled to traveling in the decelerating manner along an edge, and the robot is allowed to collide with the target obstacle in an edge-following traveling process such that the robot determines a specific position of the target obstacle through collision, and does not get stuck by the sofa-type obstacle after entering the bottom of the sofa-type obstacle in an edge-following manner; and the third preset sofa height is greater than the first preset sofa height, and the second preset sofa height is greater than the third preset sofa height.

Further, the third preset sofa height is set as 110 mm, the second preset sofa height is set as 90 mm, and the first preset sofa height is set as 50 mm; and the sofa-type obstacle includes a furniture obstacle for the robot to pass through.

Further, the step 2 further includes: under a condition that the robot currently executes [symbol] -shaped traveling, the robot is controlled to travel in a decelerating manner after the target obstacle is classified into the electric-wire-type obstacle and the longitudinal height of the target obstacle which is obtained by calculating is greater than a first preset electric wire height, simultaneously whether the robot triggers the collision warning signal is determined, in a case that yes, the robot is controlled to stop traveling in the decelerating manner, and the obstacle detected in the current traveling direction is avoided on the basis of the detection information of the infrared sensor, and in a case that not, when a depth distance between the robot and the target obstacle is a first electric wire safety distance, the robot is controlled to rotate by 90° in a first preset clockwise direction, move forward by a fourth preset distance, rotate by 90° in the first preset clockwise direction, and move forward, so as to implement right-angle turning; and under a condition that the robot currently executes global edge-following traveling, the robot is controlled to travel in the decelerating manner after the target obstacle is classified into the electric-wire-type obstacle and the longitudinal height of the target obstacle which is obtained by calculating is greater than the first preset electric wire height, simultaneously whether the robot triggers the collision warning signal is determined, in a case that yes, the robot is controlled to stop traveling in the decelerating manner, and avoiding the obstacle detected in a current edge-following direction on the basis of the detection information of the infrared sensor, and in a case that not, when a depth distance between the robot and the target obstacle is a second electric wire safety distance, the robot is controlled to rotate by 90° in a second preset clockwise direction, move forward by a fifth preset distance, rotate by 90° in a reverse direction of the second preset clockwise direction, and move forward by a sixth preset distance; whether other obstacles are present on an original global edge-following path is detected by rotating by a second observation angle, in a case that yes, the detected obstacle is bypassed by third preset moving radian in an obstacle-bypassing traveling mode, and returned to the original global edge-following traveling path, and in a case that not, the target obstacle is bypassed by fourth preset moving radian, and returned to the original global edge-following path; and when the robot executes the [symbol] -shaped traveling and the global edge-following traveling, the infrared sensor on the robot detects the obstacle in real time; the fourth preset distance, the fifth preset distance and the sixth preset distance are all related to a contour width of the target obstacle collected by the TOF camera, and the contour width is a horizontal distance between a leftmost side and a rightmost side of the target obstacle in an overlapping region of the field-of-view area of the TOF camera and an effective distance measurement range; the first electric wire safety distance is related to the depth information measured in a process that the robot executes the [symbol] -shaped traveling; and the second electric wire safety distance is related to the depth information measured in a process that the robot executes the global edge-following traveling.

Further, the first preset electric wire height is set as 5 mm, and the electric-wire-type obstacle includes an entanglement. Further, the data stability statistical algorithm is to classify the depth and the longitudinal height of the target obstacle on the basis of filtration and statistical algorithms, so as to establish a three-dimensional contour of the target obstacle, and classify the target obstacle into a wall model, a toy model, a doorsill model, a sofa model and an electric wire model.

### BRIEF DESCRIPTION OF THE DRAWINGS

FIG. 1 is a flow diagram of a method for controlling of obstacle avoidance according to a classification of an obstacle based on a time-of-flight (TOF) camera provided in Example 1 of the disclosure.

FIG. 2 is a flow diagram of a method for controlling of obstacle avoidance according to a classification of an obstacle based on a time-of-flight (TOF) camera provided in Example 2 of the disclosure.

FIG. 3 is a flow diagram of a method for controlling of obstacle avoidance according to a classification of an obstacle based on a time-of-flight (TOF) camera provided in Example 3 of the disclosure.

FIG. 4 is a flow diagram of a method for controlling of obstacle avoidance according to a classification of an obstacle based on a time-of-flight (TOF) camera provided in Example 4 of the disclosure.

FIG. 5 is a flow diagram of a method for controlling of obstacle avoidance according to a classification of an obstacle based on a time-of-flight (TOF) camera provided in Example 5 of the disclosure.

FIG. 6 is a flow diagram of a method for controlling of obstacle avoidance according to a classification of an obstacle based on a time-of-flight (TOF) camera provided in Example 6 of the disclosure.

FIG. 7 is a flow diagram of a method for controlling of obstacle avoidance according to a classification of an obstacle based on a time-of-flight (TOF) camera provided in Example 7 of the disclosure.

### DETAILED DESCRIPTION OF THE EMBODIMENTS

The technical solutions in examples of the disclosure will be described in detail below in combination with accompanying drawings in the examples of the disclosure. It should be noted that the full text of Chinese patent CN 111624997 A is cited into the text of the disclosure. On a basis of a trigonometric principle calculation method of CN 111624997 A, a relative coordinate position of a target obstacle, longitudinal height of a spaces occupied by the target obstacle, a horizontal distance (contour width) between a leftmost side of the target obstacle and a rightmost side of the target obstacle is calculated from depth information collected by a time-of-flight (TOF) camera according to intrinsic parameters and extrinsic parameters of the TOF camera.

A depth image is also referred to as a distance image, and refers to an image in which a distance between each pixel point of the depth image and an actual measurement point of a corresponding obstacle photographed is used as a pixel value. A deflection angle between each pixel point and the corresponding measurement point is determined on the basis of a set parameter of a photographing device. The depth image directly reflects a geometric shape contour of a visible surface of each obstacle in a photographed physical scene, and the depth image can be converted into spatial point cloud data according to coordinate conversion. Each the obstacle described by depth data in the depth image can be used as an image of an obstacle to be identified for subsequent processing. The obstacle should generally include objects temporarily placed on a traveling plane and objects less likely to move. According to an actual application environment, the traveling plane of the robot includes but is not limited to the following categories: a cement floor, a painted floor, a composite floor, a solid wood floor, a carpet floor, a desktop, a glass surface, etc. Examples of the objects temporarily placed on the traveling plane include: doorsills (a robot is allowed to pass over), toys (a robot is not allowed to collide), electric wires (a robot is not allowed to pass over) and other objects. Examples of the objects not easy to move include: sofas (a robot is controlled to not enter in a case that heights under the sofas are lower than a height of the robot), walls, etc.

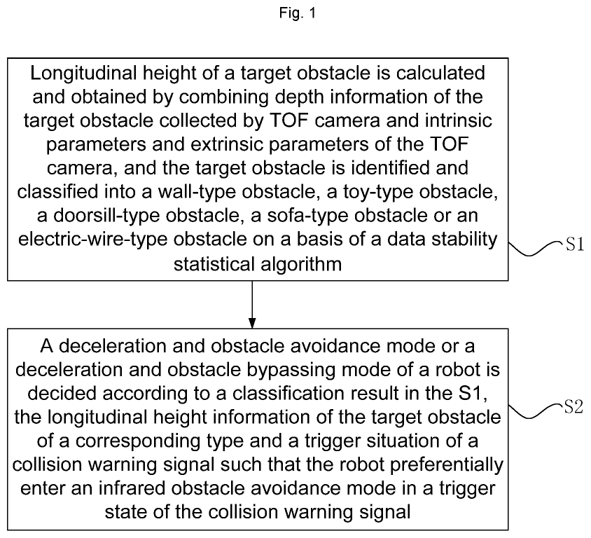

A method for controlling of obstacle avoidance according to a classification of an obstacle based on a time-of-flight (TOF) camera is disclosed as Example 1. An executive body of the method for controlling of obstacle avoidance according to the classification of the obstacle based on the TOF camera is a robot provided with a TOF camera and an infrared sensor at a front end of a robot body, which includes but is not limited to a sweeping robot. As shown in FIG. 1, the method for controlling of obstacle avoidance according to the classification of the obstacle based on the TOF camera includes: step 1: longitudinal height of a target obstacle is calculated and obtained by combining depth information of the target obstacle collected by the TOF camera and intrinsic parameters and extrinsic parameters of the TOF camera, and the target obstacle is identified and classified into a wall-type obstacle, a toy-type obstacle, a doorsill-type obstacle, a sofa-type obstacle or an electric-wire-type obstacle on a basis of a data stability statistical algorithm; and proceed to step 2. A collected target obstacle is in a current field-of-view area of the TOF camera and is located in front of the robot. In this step, the depth image information collected by the TOF camera is subjected to filtration and connected component analysis to mark out an image contour of the target obstacle, which includes spatial contour features of the target obstacle and shape features of the target obstacle, so as to analyze a shape and a range of the target obstacle. Then, an actual physical size of the target obstacle is calculated by combining depth information of the target obstacle collected by the TOF camera and intrinsic parameters and extrinsic parameters of the TOF camera, which includes longitudinal height of the target obstacle. After the actual physical size of the target obstacle is calculated, the target obstacle is identified and classified into a wall-type obstacle, a toy-type obstacle, a doorsill-type obstacle, a sofa-type obstacle and an electric-wire-type obstacle on the basis of the data stability statistical algorithm, specifically, the depth information and the longitudinal height of the target obstacle is classified and processed on a basis of filtration and statistical algorithms. In some examples, it is further required to identify the type of the obstacle according to gray data of the contour shapes of the target obstacle, so as to establish a three-dimensional contour of the target obstacle, and further classify the target obstacle into a wall model, a toy model, a doorsill model, a sofa model and an electric wire model. Surrounding three-dimensional coordinate information can be detected, so as to locate the obstacle situations in front of the robot.

The filtration algorithm for depth image data includes median filtration, Gaussian filtration, guided filtration, bilateral filtration, mean filtration, time domain median filtration, statistical filtration, through filtration, radius filtration, and voxel filtration. The connected component analysis includes two-pass and seed-filling.

It should be noted that TOF is an abbreviation of time of flight, that is, a sensor emits modulated near-infrared light, the modulated near-infrared light is reflected after encountering an object, and the sensor calculates and converts a time difference or phase difference between light emission and light reflection into a distance of a photographed scene, so as to generate depth information. In addition, in combination with traditional camera shooting, the three-dimensional contour of the object can be presented in a terrain image mode in which different colors represent different distances, so as to obtain a three-dimensional model. The TOF camera is a camera that collects data through TOF technology.

Step S2: a deceleration and obstacle avoidance mode or a deceleration and obstacle bypassing mode of the robot is decided according to the classification result in the step S1, the longitudinal height of the target obstacle of a corresponding type and a trigger situation of a collision warning signal such that the robot preferentially enter an infrared obstacle avoidance mode in a trigger state of the collision warning signal. In this step, it is further required to decide the deceleration and obstacle avoidance mode or the deceleration and obstacle bypassing mode of the robot in the case of triggering the collision warning signal or not triggering the collision warning signal by combining a working motion mode of the robot, and type features and occupied height spaces of the target obstacle which is identified in front of the robot body or in the current traveling direction such that when being close to the obstacle, the robot can avoid the obstacle in advance to achieve a non-collision function, or bypass the obstacle to move forward. Moreover, the robot can avoid dangerous obstacle in time when detecting the dangerous obstacle, and decelerate in time when encountering large objects such as furniture, a wall, etc. to avoid high-speed impact, so as to protect the furniture and the wall. The robot in the infrared obstacle avoidance mode avoids the obstacle detected in the current traveling direction on the basis of detection information of the infrared sensor.

The deceleration and obstacle avoidance mode is a mode that controls the robot to decelerate and avoid the target obstacle. The deceleration and obstacle bypassing mode is a mode that controls the robot to decelerate and bypass the target obstacle.

The collision warning signal is generated at least when it is detected that the current traveling direction of the robot has a tendency of colliding with the target obstacle.

It should be noted that when the robot is close enough to the obstacle and enters a pre-warning region set around the obstacle, a signal of detecting obstacle by the TOF camera is triggered, certainly, a hollow portion at a bottom of the furniture is not required to be triggered, since this hollow portion allows the robot to pass through and no collision occurs. Then, when the robot detects that a relative position of the target obstacle and the robot satisfy certain space region conditions, it is pre-determined that collision will occur in a case that the robot continues to travel in the current traveling direction, such that the collision warning signal is triggered, and the robot changes the current traveling direction according to the feedback of the collision warning signal.

In above steps, on the basis of depths information of large furniture and small parts that have different heights in an actual home environment, a type of the obstacle is pre-identified, and an obstacle avoidance measure is used for a relatively high obstacle in advance. When the robot approaches the target obstacle, the robot is controlled to preferentially process the triggered collision warning signal to enter the obstacle avoidance mode, and colliding with the obstacle at a high speed is avoided by entering the deceleration and obstacle avoidance mode or the deceleration and obstacle bypassing mode in advance, such that an obstacle avoidance effect of the robot is improved, and it is not required to call excessive image information for training operations.

In a specific implementation process, there are at least features as follows: according to states (normal linear traveling, original turning, radian turning and edge following) of current motions of the robot and the type of the obstacle, it is determined to adjust a current pose of the robot such that the robot can linearly pass the obstacle before passing through the obstacle and passing over the obstacle, adjust a current pose of the robot such that the robot executes obstacle-bypassing traveling or linear obstacle-avoiding traveling before small obstacle (including small entanglements) but does not touch the obstacle, or adjust a current pose of the robot such that the robot can execute edge-following obstacle avoidance when approaching the wall. Certainly, it is further related to the shape features of the obstacle which is identified, the shape features are geometric shapes, geometric shape combinations, etc. which is composed or abstracted at least one of following: contour lines, feature points, and are used for matching each obstacle type. The geometric shapes and the geometric shape combinations can be represented on the basis of full contours or part of contours of the obstacle which is identified. For example, the shape features set on the basis of island types include one or combinations of more of the following shapes: a round, a sphere, a camber, a square, a cubic, a π-shaped, etc. For example, shape features of shoes include a plurality of cambered shapes connected end to end; and shape features of chairs includes a π-shaped and an eight-claw shape, etc. The shape features set on the basis of entanglement types include at least one or combinations of more of the following shapes: a curved shape, a snake-like shape, a coiled shape, etc. The shape features set on the basis of space separation types include at least one or combinations of more of the following shapes: a linear shape, a broken line shape, a rectangle, etc.

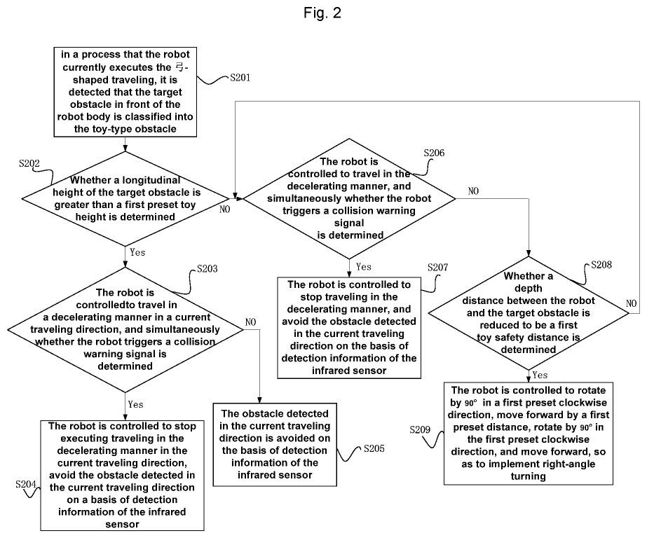

In Example 2, the robot executes [symbol] -shaped traveling to avoid the toy-type obstacle, as shown in FIG. 2, specific steps of the method for controlling of obstacle avoidance according to the classification of the obstacle based on the TOF camera include: step S201: in a process that the robot currently executes the [symbol] -shaped traveling, after it is detected that the target obstacle in front of the robot body is classified into the toy-type obstacle, proceed to step S202. Herein, the front of the robot body is the front of the traveling direction of the robot or in an overlapping region of an angle of view of the TOF camera and the effective distance measurement range.

Step S202: whether a longitudinal height of the target obstacle is greater than a first preset toy height is determined, in a case that yes, proceed to step S203, and in a case that not, proceed to step S206. In some embodiments, the first preset toy height is set as 65 mm; and the toy-type obstacle includes an island-type obstacle.

Step S203: the robot is controlled to travel in a descending manner in the current traveling direction, such that the robot goes straight in a descending manner to approach the toy-type obstacle, and simultaneously whether the robot triggers a collision warning signal is determined, in a case that yes, proceed to step S204, and in a case that not, proceed to step S205.

Step S204: the robot is controlled to stop executing traveling in a decelerating manner in the current traveling direction, avoid the obstacle detected in the current traveling direction on a basis of the detection information of the infrared sensor, and directly execute infrared obstacle avoidance after the collision warning signal is triggered since the robot will collide with the target obstacle in a case that the robot continues to travel in the current traveling direction. Therefore, the robot avoids the target obstacle without collision in an infrared obstacle avoidance mode, and then returns to an original traveling mode.

Step S205: the obstacle detected in the current traveling direction is avoided on the basis of detection information of the infrared sensor when the robot travels in the decelerating manner in the current traveling direction.

Step S206: the robot is controlled to travel in the decelerating manner along an originally planned [symbol] -shaped path, and simultaneously whether the robot triggers the collision warning signal is determined, in a case that yes, proceed to step S207, and in a case that not, proceed to step S208.

Step S207: the robot is controlled to stop traveling in the decelerating manner in the step S206, so as to effectively control the robot to pass over small toys without collision, and avoid the obstacle detected in a current traveling direction on the basis of detection information of the infrared sensor. Therefore, regardless of a height of the toy-type obstacle, the robot preferentially enters the infrared obstacle avoidance mode after the collision warning signal is triggered. Therefore, the robot avoids the target obstacle without collision in the infrared obstacle avoidance mode, and then returns to an original traveling mode.

Step S208: in a process that the robot travels in the decelerating manner along the originally planned [symbol] -shaped path, whether a depth distance between the robot and the target obstacle is reduced to be the first toy safety distance is determined, or whether the depth distance between the robot and the target obstacle equals the first toy safety distance or within an error value range of the first toy safety distance is determined, in a case that yes, proceed to step S209, and in a case that not, return to the step S206 to detect whether the robot traveling in the decelerating manner triggers the collision warning signal. And the first toy safety distance is related to the depth information measured in a process that the robot executes the [symbol] -shaped traveling, and limits the robot from colliding with the target obstacle before the robot decelerates to zero, so as to protect the target obstacle.

Step S209: the robot is controlled to rotate by 90° in a first preset clockwise direction, move forward by a first preset distance, rotate by 90° in the first preset clockwise direction, and move forward, so as to implement right-angle turning, and avoid the dangerous obstacle in time before the robot tends to collide with the obstacle. And the first preset distance is related to the contour width of the same toy-type obstacle collected by the TOF camera, and the contour width is a horizontal distance between a leftmost side and a rightmost side of the toy-type obstacle in a field-of-view area of the TOF camera, which is obtained by calculating in the step S201 and the step S202 in the example. In an angle of view of the TOF camera, the greater a horizontal distance between the leftmost side of the toy-type obstacle and the center of the robot body, the greater the first preset distance by which the robot goes straight after turning left. In the angle of view of the TOF camera, the greater a horizontal distance between the rightmost side of the toy-type obstacle and the center of the robot body, the greater the first preset distance by which the robot goes straight after turning right; otherwise, the less the first preset distance.

When the first preset clockwise direction is a clockwise direction, the second preset clockwise direction can be the clockwise direction or a counter-clockwise direction. When the first preset clockwise direction is the counter-clockwise direction, the second preset clockwise direction can be the clockwise direction or the counter-clockwise direction.

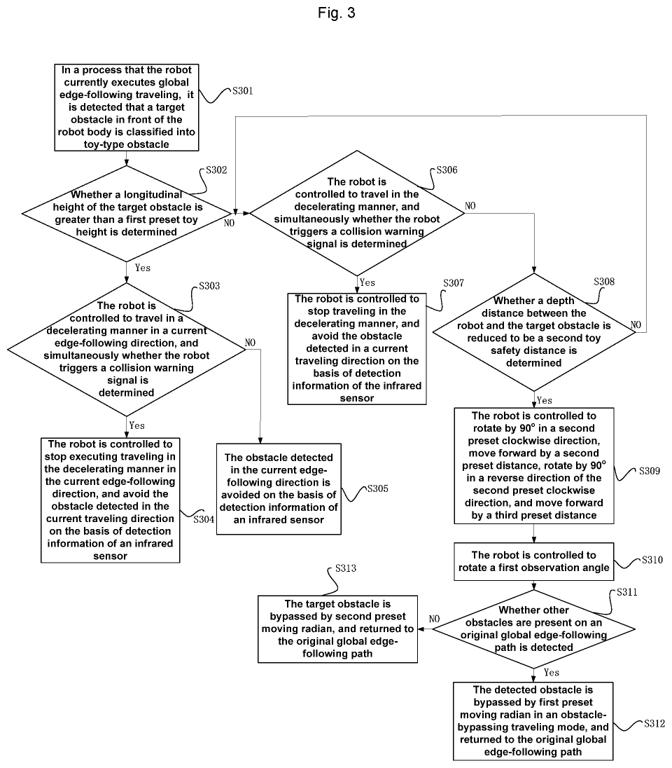

On the basis of Example 2, Example 3 discloses the method for controlling of obstacle avoidance according to the classification of the obstacle based on the TOF camera, as shown in FIG. 3, which specifically includes: step S301: in a process that the robot currently executes global edge-following traveling, after it is detected that a target obstacle in front of the robot body is classified into toy-type obstacle, proceed to step S302. Herein, the front of the robot body is in the traveling direction of the robot or in an overlapping region of an angle of view of the TOF camera and the effective distance measurement range.

Step S302: whether the longitudinal height of the target obstacle is greater than a first preset toy height is determined, in a case that yes, proceed to step S303, and in a case that not, proceed to step S306. In some embodiments, the first preset toy height is set as 65 mm; and the toy-type obstacle includes an island-type obstacle.

Step S303: the robot is controlled to travel in a descending manner in the current edge-following direction, such that the robot goes straight in the descending manner to approach the toy-type obstacle, and simultaneously whether the robot triggers a collision warning signal is determined, in a case that yes, proceed to step S304, and in a case that not, proceed to step S305.

Step S304: the robot is controlled to stop executing traveling in the decelerating manner in the current edge-following direction, avoid the obstacle detected in the current traveling direction on the basis of the detection information of the infrared sensor, and directly execute infrared obstacle avoidance after the collision warning signal is triggered since the robot will collide with the target obstacle in a case that the robot continues to travel in the current edge-following direction. Therefore, the robot avoids the target obstacle without collision in an infrared obstacle avoidance mode, and then returns to an original traveling mode.

Step S305: the obstacle detected in the current edge-following direction is avoided on the basis of detection information of an infrared sensor when the robot travels in the decelerating manner in the current edge-following direction.

Step S306: the robot is controlled to travel in the decelerating manner along a global edge-following path, and simultaneously whether the robot triggers the collision warning signal is determined, in a case that yes, proceed to step S307, and in a case that not, proceed to step S308.

Step S307: the robot is controlled to stop traveling in the decelerating manner in the step S306, so as to effectively prevent the robot from passing over a relatively short toy obstacle, and avoid the obstacle detected in the current traveling direction on the basis of detection information of the infrared sensor. Therefore, the robot avoids the target obstacle without collision in the infrared obstacle avoidance mode, and then returns to an original traveling mode. Therefore, regardless of a height of the toy-type obstacle and the current traveling mode of the robot, the robot preferentially enters the infrared obstacle avoidance mode after triggering a collision warning signal.

Step S308: whether a depth distance between the robot and the target obstacle is reduced to be a second toy safety distance is determined, or whether the depth distance between the robot and the target obstacle is the second toy safety distance or within an error value range of the second toy safety distance is determined; in a case that yes, proceed to step S309; and in a case that not, return to step S306 to detect whether the robot triggers the collision warning signal. The second toy safety distance is related to the depth information measured in a process that a robot currently the executes [symbol] -shaped traveling, and can be a safety threshold set on the basis of the contour shapes of the target obstacle, so as to limit the robot from colliding with the target obstacle before the robot decelerates to zero, thereby protecting the target obstacle.

Step S309: the robot is controlled to rotate by 90° in a second preset clockwise direction, move forward by a second preset distance, that is, move forward by the second preset distance in the current traveling direction, rotate by 90° in a reverse direction of the second preset clockwise direction, and move forward by a third preset distance, that is, move forward by the third preset distance in the current traveling direction, so as to start obstacle-bypassing traveling, and then proceed to step S310. It should be noted that in the step S309, the robot can travel in the decelerating manner or not travel in the decelerating manner, since after the depth distance between the robot and the target obstacle is the second toy safety distance, the robot starts to change the traveling direction, and can no longer tend to collide with the target obstacle. The second preset distance and the third preset distance are both related to the contour width of the same target obstacle collected by the TOF camera of the robot on the [symbol] -shaped path, and the contour width is a horizontal distance between the leftmost side and the rightmost side of the same target obstacle in the field-of-view area of the TOF camera, which is calculated in the step S301 and the step S302 in the example, and depth data of the same target obstacle is simultaneously measured. In an angle of view of the TOF camera, the greater a horizontal distance between the leftmost side of the same toy-type obstacle and the center of the robot body, the greater the second preset distance by which the robot goes straight after turning left. In the angle of view of the TOF camera, the greater a horizontal distance between the rightmost side of the same toy-type obstacle and the center of the robot body, the greater the second preset distance by which the robot goes straight after turning right; otherwise, the less the second preset distance. Regardless of whether the robot turns right or left, in a case that the greater the depth data of the same toy-type obstacle, the greater the third preset distance, otherwise, the less the third preset distance.

Step S310: the robot is controlled to rotate by a first observation angle, and then proceed to step S311. The rotation direction of the robot in this step can be the second preset clockwise direction or reverse direction of the second preset clockwise direction, such that a traveling direction in which the robot moves forward by a third preset distance in the step S309 is changed to detect whether there is an obstacle on the global edge-following path in the step S301, for example, whether there is the obstacle in front of a wall along which the original global edge-following traveling is executed.

Step S311: whether other obstacles are present on the global edge-following path is detected in the step S301, in a case that yes, proceed to step S312, and in a case that not, proceed to step S313. The other obstacles herein are obstacles in the current field-of-view area of the TOF camera of the robot in addition to the above target obstacle.

Step S312: the detected obstacle is bypassed by first preset moving radian in an obstacle-bypassing traveling mode, and returned to the original global edge-following path, such that original global edge-following traveling of the robot is restored. The obstacle in this step includes the obstacle detected in the step S311 and the above target obstacle.

Step S313: the target obstacle is bypassed by second preset moving radian, and returned to the original global edge-following path, and the second preset moving radian is less than the first preset moving radian.

According to Examples 2 and Examples 3, before the robot touches a relatively high toy obstacle, the robot is controlled to identify the type of the obstacle in advance and move forward in the decelerating manner to approach the obstacle, simultaneously keeps detecting an infrared detection signal and the collision warning signal, stops moving forward in the decelerating manner after receiving the collision warning signal to independently execute infrared obstacle avoidance, keeps moving forward in the decelerating manner and infrared obstacle avoidance when not receiving the collision warning signal, so as to avoid the relatively high toy obstacle in advance, thereby reducing the probability of closely touching the relatively high toy obstacle. According to Examples 2 and Examples 3, before the robot touches a relatively short and small toy obstacle, on the basis of traveling in the decelerating manner and triggering and processing the collision warning signal, the robot is avoided from colliding with a relatively short and small toy obstacle through right-angle turning and obstacle-bypassing traveling, the robot is prohibited from passing over the relatively short and small toy obstacle, and it is guaranteed that the robot returns to an originally planned working path after avoiding the obstacle or bypassing the obstacle, such that interference of the obstacle in work of the robot is reduced.

As an Example, the step S2 further includes: under a condition that the robot currently executes [symbol] -shaped traveling or global edge-following traveling, the robot is controlled to travel in a decelerating manner to pass over a doorsill after the target obstacle is classified into the doorsill-type obstacle; and the doorsill-type obstacle includes an obstacle for the robot to pass over. Specifically, under a condition that the robot currently executes the [symbol] -shaped traveling, the robot is controlled to travel in the decelerating manner along a [symbol] -shaped path after the target obstacle is classified into the doorsill-type obstacle, simultaneously whether the robot triggers the collision warning signal can be determined, in a case that yes, the [symbol] -shaped traveling is stopped, and the obstacle detected in the current traveling direction is avoided on the basis of the detection information of the infrared sensor, and in a case that not, traveling in a decelerating manner is kept to pass over the doorsill. Under a condition that the robot currently executes the global edge-following traveling, the robot is controlled to travel in the decelerating manner along a global edge-following path to pass over the doorsill after the target obstacle is classified into the doorsill-type obstacle, simultaneously whether the robot triggers the collision warning signal can be determined, in a case that yes, the [symbol] -shaped traveling is stopped, and the obstacle detected in the current traveling direction is avoided on the basis of the detection information of the infrared sensor, and in a case that not, traveling in a decelerating manner is kept to pass over the doorsill; and the doorsill-type obstacle includes an obstacle for the robot to pass over. According to the Example, after the doorsill is identified, the robot moves forward in the decelerating manner to pass over the doorsill, so as to avoid the robot from impacting the threshold at a high speed, thereby protecting the doorsill.

As an Example, the step S2 further includes: under a condition that the robot currently executes [symbol] -shaped traveling, the robot is controlled to keep executing the original [symbol] -shaped traveling mode after the target obstacle is classified into the wall-type obstacle, and simultaneously whether the robot triggers the collision warning signal is determined, in a case that yes, the [symbol] -shaped traveling is stopped, and the obstacle detected in the current traveling direction is avoided on the basis of the detection information of the infrared sensor, and in a case that not, the obstacle detected in the current traveling direction is avoided on the basis of the detection information of the infrared sensor; such that a wall is not touched in the [symbol] -shaped traveling process. Under a condition that the robot currently executes global edge-following traveling, the robot is controlled to keep executing the original edge-following traveling mode, and simultaneously whether the robot triggers the collision warning signal is determined, in a case that yes, the edge-following traveling is stopped, and the obstacle detected in the current traveling direction is avoided on the basis of the detection information of the infrared sensor, and in a case that not, the original edge-following traveling mode is kept. The robot can be advantageously controlled to obtain the optimal edge-following direction through adjustment such that the robot can adjust the current edge-following mode, but the robot cannot collide with the wall in the edge-following traveling process. According to the Example, the robot is controlled not to execute infrared obstacle avoidance in a wall-following traveling process, and the infrared obstacle avoidance mode is selected according to a trigger state of the collision warning signal in the case of no wall-following traveling, which includes: whether it is required to stop the original traveling mode to execute the infrared obstacle avoidance is determined, so as to prevent the robot from frequently colliding with a wall, thereby protecting relatively high furniture such as the wall.

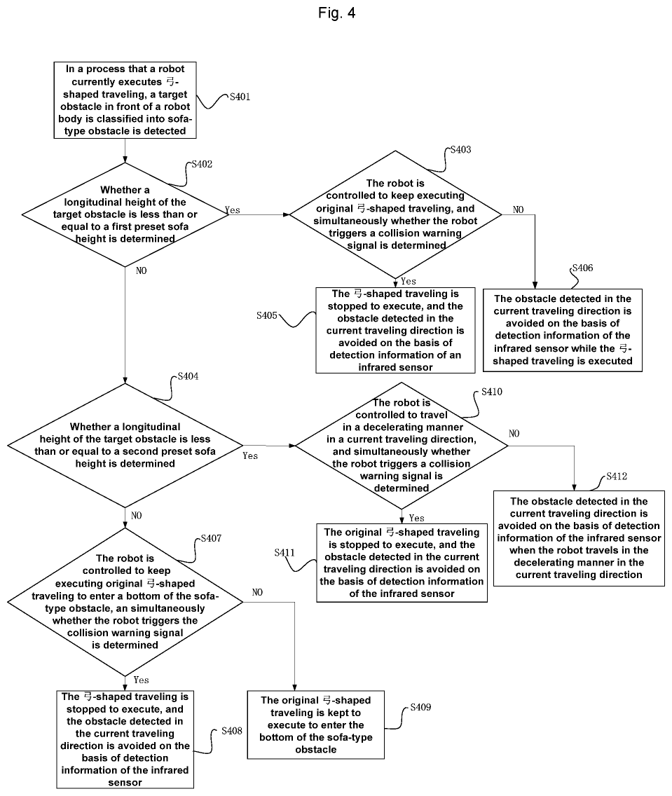

Example 4 discloses an example of the obstacle avoidance according to the classification of the obstacle of sofa-type, as shown in FIG. 4, which specifically includes: Step S401: in a process that a robot currently executes [symbol] -shaped traveling, a target obstacle in front of a robot body is classified into sofa-type obstacle is detected, and proceed to step 402. Herein, the front of the robot body is in the traveling direction of the robot or in an overlapping region of an angle of view of the TOF camera and an effective distance measurement range.

Step S402: whether a longitudinal height of the target obstacle is less than or equal to a first preset sofa height is determined, in a case that yes, proceed to step S403, and in a case that not, proceed to step S404. In some embodiments the first preset sofa height is set as 50 mm; and the sofa-type obstacle include a furniture obstacle for the robot to pass through.

Step S403: the robot is controlled to keep executing the original [symbol] -shaped traveling, and maintain the original traveling mode, such that the robot is not required to travel in a decelerating manner, and simultaneously whether the robot triggers a collision warning signal is determined, in a case that yes, proceed to step S405, and in a case that not, proceed to step S406.

Step S405: the original [symbol] -shaped traveling is stopped to execute and the obstacle detected in the current traveling direction is avoided on the basis of detection information of an infrared sensor such that the robot avoids the target obstacle without collision in an infrared obstacle avoidance mode, and then returns to an original traveling mode. Since the robot will collide with the target obstacle in a case that the robot continues to travel in the current traveling direction, the robot directly executes infrared obstacle avoidance after the collision warning signal is triggered, executes avoidance in advance on the premise of not touching the target obstacle, and quickly returns to the original [symbol] -shaped traveling mode.

Step S406: the obstacle detected in the current traveling direction is avoided on the basis of the detection information of the infrared sensor while the robot executes the original [symbol] -shaped traveling and keeps the original traveling mode.

Step S404: whether the longitudinal height of the target obstacle is less than or equal to a second preset sofa height is determined, in a case that yes, proceed to step S410, and in a case that not, proceed to step S407, that is, whether the longitudinal height of the target obstacle is greater than the first preset sofa height and less than or equal to the second preset sofa height is determined. In some embodiments, the third preset sofa height is set as 110 mm, and the first preset sofa height is set as 50 mm. And the sofa-type obstacle includes a furniture obstacle for the robot to pass through. Therefore, a large obstacle which the robot allowed to touch or even pass through is identified.

Step S410: the robot is controlled to travel in a descending manner in the current traveling direction, and simultaneously whether the robot triggers a collision warning signal is determined, in a case that yes, proceed to step S411, and in a case that not, proceed to step S412.

Step S411: the original [symbol] -shaped traveling is stopped to execute, and the obstacle detected in the current traveling direction is avoided on the basis of detection information of the infrared sensor such that the robot avoids the target obstacle without collision in an infrared obstacle avoidance mode, and then returns to an original traveling mode. Since the robot will collide with the target obstacle in a case that the robot continues to travel in the current traveling direction, the robot directly executes infrared obstacle avoidance after the collision warning signal is triggered, and quickly returns to the original [symbol] -shaped traveling mode.

Step S412: the obstacle detected in the current traveling direction is avoided on the basis of detection information of the infrared sensor when the robot travels in the decelerating manner in the current traveling direction, which includes: the classified target obstacle is avoided.

Step S407: in this case, the longitudinal height of the target obstacle is greater than the second preset sofa heights is determined, the robot is controlled to keep executing the original [symbol] -shaped traveling to enter the bottom of the sofa-type obstacle without deceleration, and simultaneously whether the robot triggers a collision warning signal is determined, in a case that yes, proceed to step S408, and in a case that not, proceed to step S409. It should be noted that under a condition that the type of the target obstacle is furniture that the robot can pass through, the robot is controlled to keep in the current traveling direction, but also is required to execute an obstacle avoidance action to minimize the impact of an obstacle other than the sofa on a normal working behavior of the robot in a process of passing through the bottom of the sofa, but the robot cannot collide with the sofa in a [symbol] -shaped traveling process. And the second preset sofa height is greater than the robot body height of the robot; and the second preset sofa height is greater than the first preset sofa height.

Step S408: the original [symbol] -shaped traveling is stopped to execute, and the obstacle detected in the current traveling direction is avoided on the basis of detection information of the infrared sensor such that the robot avoids other obstacles other than the target obstacle without collision in an infrared obstacle avoidance mode, and then returns to an original traveling mode, so as to smoothly enter the bottom of the sofa. Since the robot will collide with other obstacles other than the sofa-type obstacle in a process of continuously executing [symbol] -shaped traveling to enter the bottom of the sofa, the robot directly executes infrared obstacle avoidance after the collision warning signal is triggered, so as to avoid the other obstacles on the premise of no collision, and the robot smoothly enters the sofa to continue to execute the [symbol] -shaped traveling by relying on the infrared obstacle avoidance.

Step S409: the original [symbol] -shaped traveling is kept to execute to enter the bottom of the sofa-type obstacle such that the robot can enter the bottom of the sofa without deceleration.

By executing the method for controlling of obstacle avoidance according to the classification of the obstacle based on the TOF camera described in the steps S401 to S412, according to the Example, after the sofa, which is an obstacle for a robot to pass through, is identified in a moving forward direction of the robot, whether the robot enters the bottom of the sofa and a deceleration and obstacle avoidance mode are determined according to the triggered collision warning signal and ranges where the longitudinal height of the sofa is within, the robot directly executes infrared obstacle avoidance to avoid touch under a condition that the height of the sofa is relatively small (the robot cannot enter the bottom of the sofa), the robot moves forward in a decelerating manner and keeps infrared obstacle avoidance to avoid impacting the sofa at a high speed under a condition that the height of the sofa is moderate (part of the robot can enter the bottom of the sofa), and the robot is not required do decelerate and directly enters the sofa in the original traveling mode under a condition that the height of the sofa is relatively large (the robot can completely enter the bottom of the sofa), so as to improve work efficiency of the robot and effectiveness of obstacle avoidance.

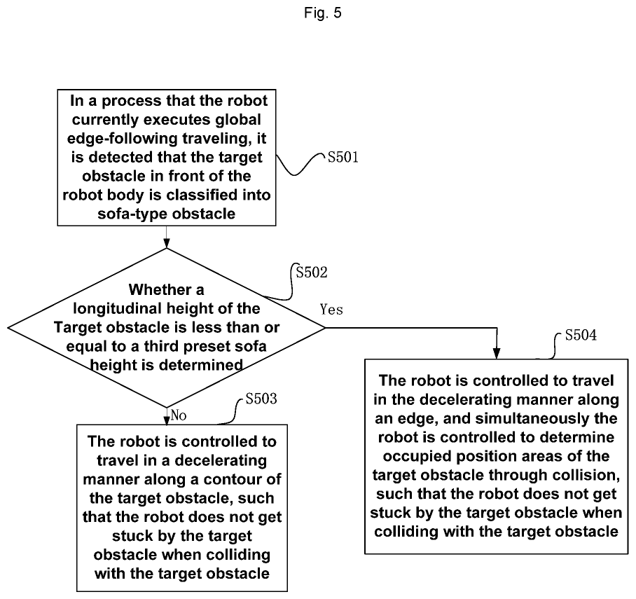

On the basis of Example 4, Example 5 discloses the method for controlling of obstacle avoidance according to the classification of the obstacle based on the TOF camera, as shown in FIG. 5, which specifically includes: step S501: in a process that the robot currently executes global edge-following traveling, after it is detected that the target obstacle in front of the robot body is classified into sofa-type obstacle, proceed to step S502. Herein, the front of the robot body is in the traveling direction of the robot or in an overlapping region of an angle of view of the TOF camera and an effective distance measurement range. That is, after it is determined that a traveling mode currently executed by the robot is the global edge-following traveling, the following deceleration and obstacle avoidance mode starts to be executed.

Step S502: whether the longitudinal height of the target obstacle is less than or equal to a third preset sofa height is determined, in a case that yes, proceed to step S504, and in a case that not, proceed to step S503.

Step S503: the robot is controlled to travel in a decelerating manner along a contour of the target obstacle, such that the robot does not get stuck by the target obstacle when colliding with the target obstacle. In the Example, the robot is allowed to occasionally collide with the sofa, but is not allowed to get stuck.

In some implementation scenarios, in a process that the robot passes through the bottom of the sofa furniture through an edge-following traveling method, the robot can execute edge-following traveling around a supporting portion at the bottom of the sofa-type obstacle. In this case, the robot is allowed to collide with the sofa to execute edge-following traveling, and after the robot enters the hollow portion at the bottom of the furniture and physically collides with the supporting portion, a position detection result or obstacle type identification result of the sofa-type obstacle can be corrected.

Step S504: the robot is controlled to travel in a decelerating manner along an edge, and simultaneously the robot is controlled to determine occupied position areas of the target obstacle through collision, such that the robot does not get stuck by the target obstacle when colliding with the target obstacle, thereby the robot is allowed to occasionally collide with the sofa in some implementation scenarios, but not to be stuck. The third preset sofa height is greater than the first preset sofa height, and the second preset sofa height is greater than the third preset sofa height. In some embodiments, the second preset sofa height is set as 90 mm.

According to the Example, when the height of the sofa is identified to be moderate, the robot is allowed to collide with the sofa in a case of not being stuck into the bottom of the sofa, and the robot collides with the sofa in the decelerating manner, so as to protect the sofa, and simultaneously the specific position of the sofa are determined through collision.

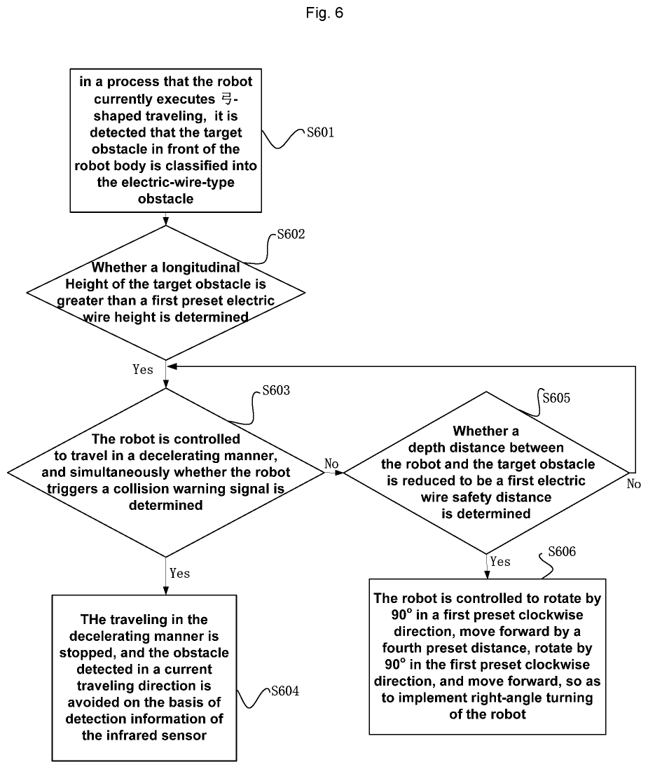

Example 6 is an example in which the robot executes [symbol] -shaped traveling to avoid the electric-wire-type obstacle, as shown in FIG. 6, specific steps of the method for controlling of obstacle avoidance according to the classification of the obstacle based on the TOF camera include: step S601: in a process that the robot currently executes [symbol] -shaped traveling, after it is detected that the target obstacle in front of the robot body is classified into the electric-wire-type obstacle, proceed to step S602. Herein, the front of the robot body is in front of the traveling direction of the robot or is in an overlapping region of an angle of view of the TOF camera and an effective distance measurement range. Therefore, after it is determined that a traveling mode currently executed by the robot is the [symbol] -shaped traveling, the following deceleration and obstacle avoidance mode starts to be executed.

Step S602: whether a longitudinal height of the target obstacle is greater than a first preset electric wire height is determined, in a case that yes, proceed to step S603. In some embodiments, the first preset electric wire height is set as 5 mm, and the electric-wire-type obstacle includes an entanglement. It is worth noting that these entanglements each has a relatively small height, which is generally less than the height of the robot body of the robot, and it is easy to guide the robot to pass over the electric-wire-type obstacle under the misjudgment condition.

Step S603: when it is detected that the electric-wire-type obstacle have obviously high heights, the robot is controlled to travel in a decelerating manner along the [symbol] -shaped path to avoid colliding with the electric-wire-type obstacle at a high speed, and simultaneously whether the robot triggers a collision warning signal is determined, in a case that yes, proceed to step S604, and in a case that not, proceed to step S605.

Step S604: the traveling in the decelerating manner is stopped, that is, the robot is effectively controlled to pass over the electric-wire-type obstacle without touch by stopping traveling in the decelerating manner along the [symbol] -shaped path, and then the obstacle detected in the current traveling direction is avoided on the basis of the detection information of the infrared sensor. Since the robot will collide with the target obstacle in a case that the robot continues to travel in the original traveling direction, the robot directly executes infrared obstacle avoidance after the collision warning signal is triggered, the robot avoids the target obstacle in time through the infrared obstacle avoidance mode, and then returns to the original traveling mode in a collision-free state.

Step S605: in a process that the robot travels in the decelerating manner along the [symbol] -shaped path, whether a depth distance between the robot and the target obstacle is reduced to be the first electric wire safety distance is determined, or whether a depth distance between the robot and the target obstacle is the first electric wire safety distance or within an error value range of the first electric wire safety distance is determined, in a case that yes, proceed to step S606, and in a case that not, return to the step S603 to detect whether the robot triggers the collision warning signal. The first electric wire safety distance is related to depth information measured in a process that a robot currently executes [symbol] -shaped traveling, so as to limit the robot from colliding with the electric-wire-type obstacle before the robot decelerates to zero, and the situation that since the robot is required to travel around the entanglements, the robot is likely to get stuck in the case of misdetecting relative positions of the entanglements is avoided.

Step S606: the robot is controlled to rotate by 90° in a first preset clockwise direction, move forward by a fourth preset distance, rotate by 90° in the first preset clockwise direction, and move forward, so as to implement right-angle turning of the robot, and the electric-wire-type obstacle is avoided in time before the robot tends to collide with the obstacle. The fourth preset distance is related to a contour width of the same wire type obstacle collected by the TOF camera, and can be obtained by scaling up and down. The contour width is a horizontal distance between the leftmost side and the rightmost side of the same electric-wire-type obstacle within the field-of-view area of the TOF camera. In an angle of view of the TOF camera, the greater a horizontal distance between the leftmost side of the electric-wire-type obstacle and the center of the robot body, the greater the fourth preset distance by which the robot goes straight after turning left. In an angle of view of the TOF camera, the greater a horizontal distance between the rightmost side of the electric-wire-type obstacle and the center of the robot body, the greater the fourth preset distance by which the robot goes straight after turning right; otherwise, the less the fourth preset distance.

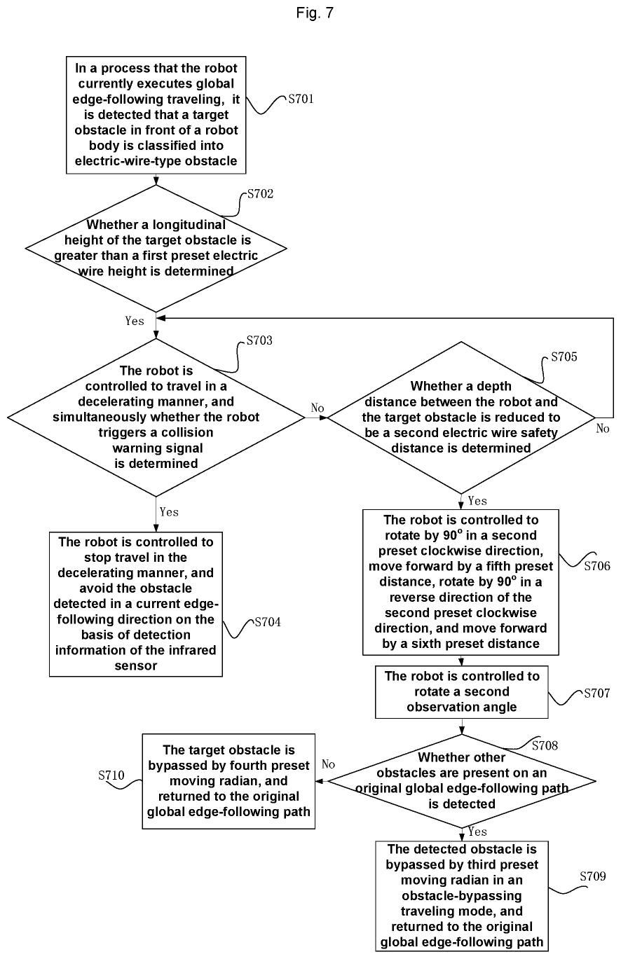

On the basis of Example 6, Example 7 discloses the method for controlling of obstacle avoidance according to the classification of the obstacle based on the TOF camera, as shown in FIG. 7, which specifically includes: step S701: in a process that the robot currently executes global edge-following traveling, after it is detected that a target obstacle in front of a robot body is classified into electric-wire-type obstacle, proceed to step S702. Herein, the front of the robot body is in the traveling direction of the robot or is in an overlapping region of an angle of view of the TOF camera and an effective distance measurement range.

Step S702: whether a longitudinal height of the target obstacle is greater than a first preset electric wire height is determined, in a case that yes, proceed to step S703.

Step S703: when it is detected that the electric-wire-type obstacle have obviously high heights, the robot is controlled to travel in a decelerating manner along the global edge-following path to avoid colliding with the electric-wire-type obstacle at a high speed, and simultaneously whether the robot triggers a collision warning signal is determined, in a case that yes, proceed to step S704, and in a case that not, proceed to step S705.

Step S704: the robot is controlled to pass over the electric-wire-type obstacle without touch by stopping edge-following traveling in the decelerating manner, and avoid the obstacle detected in the current edge-following direction on the basis of the detection information of the infrared sensor. Since the robot will collide with the target obstacle in a case that the robot continues to travel in the original traveling direction, the robot directly executes infrared obstacle avoidance after the collision warning signals is triggered, such that the robot avoids the target obstacle in an infrared obstacle avoidance mode in time, and then returns to the original traveling mode in a collision-free state. Therefore, regardless of the current traveling mode of the robot, the robot preferentially enters the infrared obstacle avoidance mode after the collision warning signal is triggered.

Step S705: whether a depth distance between the robot and the target obstacle is reduced to be a second electric wire safety distance is determined, or whether the depth distance between the robot and the target obstacle is the second electric wire safety distance or within an error value range of the second electric wire safety distance is determined; in a case that yes, proceed to step S706; and in a case that not, return to step S703 to detect whether the robot traveling in the decelerating manner triggers the collision warning signal. It should be noted that in the step S705, the robot can travel in the decelerating manner or not travel in the decelerating manner, since after the depth distance between the robot and the target obstacle is the second electric wire safety distance, the robot starts to change the traveling direction, and can no longer tend to collide with the target obstacle, such that the robot is allowed not to travel in the decelerating manner. The second electric wire safety distance is related to depth information measured in a process that the robot executes the global edge-following traveling, and can be a safety threshold set on the basis of the contour shape of the electric-wire-type obstacle, so as to limit the robot from colliding with the electric-wire-type obstacle before the robot decelerates to zero, and the situation that since the robot is required to travel around the entanglement, the robot is likely to get stuck in the case of misdetecting a relative position of the entanglement is avoided.

Step S706: the robot is controlled to rotate by 90° in a second preset clockwise direction, move forward by a fifth preset distance (that is, move forward by the fifth preset distance in the current traveling direction), rotate by 90° in a reverse direction of the second preset clockwise direction, and move forward by a sixth preset distance (that is, move forward by the sixth preset distance in the current traveling direction), so as to start obstacle-bypassing traveling, and then proceed to step S707. In the global edge-following traveling scenario of the robot, the fifth preset distance and the fourth preset distance are both related to a contour width of the same electric-wire-type obstacle collected by the TOF camera of the robot, and the contour width is a horizontal distance between the leftmost side and the rightmost side of the same electric-wire-type obstacle in the field-of-view area of the TOF camera, which is obtained by calculated in the steps S701 and S702 in the example, and depth data of the same target obstacle is also measured. In an angle of view of the TOF camera, the greater a horizontal distance between the leftmost side of the electric-wire-type obstacle and the center of the robot body, the greater the fifth preset distance by which the robot goes straight after turning left. In an angle of view of the TOF camera, the greater a horizontal distance between the rightmost side of the electric-wire-type obstacle and the center of the robot body, the greater the fifth preset distance by which the robot goes straight after turning right; otherwise, the less the fifth preset distance. Regardless of whether the robot turns right or left, in a case that the greater the depth data of the same electric-wire-type obstacle, the greater the sixth preset distance, otherwise, the less the sixth preset distance.

Step S707: the robot is controlled to rotate by a second observation angle, and then proceed to step S708. The rotation direction of the robot in this step can be the second preset clockwise direction or reverse direction of the second preset clockwise direction, such that a traveling direction in which the robot moves forward by the sixth preset distance in the step S706 is changed to detect whether there is an obstacle on the global edge-following path in the step S701, for example, whether there is an obstacle in front of a wall along which the original global edge-following traveling is detected.

Step S708: whether other obstacles are present on the global edge-following path in the step S701 is detected, in a case that yes, proceed to step S709, and in a case that not, proceed to step S710. The other obstacles herein are obstacles within the current field-of-view area of the TOF camera of the robot in addition to the above electric-wire-type obstacle.

Step S709: the detected obstacle is bypassed by third preset moving radian in an obstacle-bypassing traveling mode, and returned to the original global edge-following path, such that original global edge-following traveling of the robot is restored. The obstacle in this step include the obstacle detected in the step S708 and the above electric-wire-type obstacle.

Step S710: the target obstacle is bypassed by fourth preset moving radian, and returned to the original global edge-following path, and the fourth preset moving radian is less than the third preset moving radian. The fourth preset distance and the fifth preset distance are both used for limiting the robot from touching the target obstacle in a process of edge-following traveling or traveling in a decelerating manner, and the fourth preset moving radian and the third preset moving radian are used for limiting the robot from touching the target obstacle in a process of obstacle-bypassing traveling. In the example, before the identified target obstacle is approached in an angle of view, collision obstacle avoidance requirements of the matched type of obstacle is satisfied by setting different safety distances, so as to predetermine obstacle-free passable regions and facilitate subsequent planning of an effective obstacle avoidance path.

In combination with Examples 6 and 7, it can be seen that after the electric-wire-type obstacle is identified in a moving forward direction of the robot, an obstacle avoidance strategy is flexibly adjusted in a decelerating traveling process according to a current motion state of the robot and the collision warning signal is triggered, such that the electric wire is avoided through a right-angle turning method after [symbol] -shaped decelerating traveling is executed by a certain safety distance, and the electric wire is bypassed in an obstacle-bypassing traveling mode after edge-following decelerating traveling is executed by a certain safety distance. After the collision warning signal is triggered, infrared obstacle avoidance is directly executed, such that the robot is controlled to avoid touching the electric wire or even passing over the electric wire before approaching the electric wire; and the robot is further controlled to return to the original traveling mode after being away from the electric wire, such that the influence of the electric-wire-type obstacle on normal work of the robot is reduced.

According to Examples 6 and 7, before the robot touches a relatively short and small entanglement obstacle, on the basis of traveling in the decelerating manner and triggering and processing the collision warning signal, the robot is prevented from colliding with the relatively short and small entanglement obstacle through right-angle turning and obstacle-bypassing traveling, the robot is prohibited from passing over the relatively short and small entanglement obstacle, and it is guaranteed that the robot returns to an originally planned working path after avoiding or bypassing the obstacle, such that interference of the obstacle in work of the robot is reduced.

It should be noted that in above example, the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model and an electric wire model. According to the example, shapes and ranges of the target obstacle is analyzed by collecting the depth output from the TOF camera such that the obstacle situation in front of the robot can be located; fitting operations are reduced; and accuracy of obstacle type identification is improved.

In above examples, the method for triggering a collision warning signal specifically includes: an actual physical size of the target obstacle is obtained by calculating according to a depth image of a contour of the target obstacle (a depth image contour of the above target obstacle) currently collected by a TOF camera, depth information of the target obstacle, and intrinsic parameters and extrinsic parameters of the TOF camera, and on this basis, set a virtual rectangular frame for surrounding the target obstacle, and the virtual rectangular frame is located on a traveling plane of the robot; and then, the robot is controlled to trigger the collision warning signal when the robot travels to an interior of a virtual rectangular frame and it is detected that the current traveling direction of the robot has a tendency of colliding with the target obstacle. In the example, a rectangular frame with collision warning significance is set on the basis of an actual physical size of the target obstacle, and the collision warning signal of the robot is triggered in the rectangular frame, such that the robot can avoid colliding an obstacle in advance in a required position region, and the influence of the target obstacle on normal work of the robot is reduced. The robot is reminded of re-planning a working path.

Specifically, the step of determining that the robot travels to the interior of the virtual rectangular frame includes: whether the sum of angles of included angles formed by three different end points of the virtual rectangular frame relative to the current traveling direction of the robot is less than 90° is determined, in a case that yes, that the robot does not travel to the interior of the virtual rectangular frame is determined, and in a case that not, the robot has travelled to the interior of the virtual rectangular frame is determined, that is, when the sum of angles of included angles formed by three different end points of the virtual rectangular frame relative to the current traveling direction of the robot is greater than or equal to 90°, the robot has travelled to the interior of the virtual rectangular frame is determined. It should be noted that the actual physical size of the target obstacle include coordinate information of four different end points of the virtual rectangular frame. The theoretical basis for determining whether the robot travels to the interior of the virtual rectangular frame is derived from the circumferential angle theorem, and the virtual rectangular frame has a circumscribed circle, and when the sum of angles of included angles formed by three different end points of the virtual rectangular frame relative to the current traveling direction of the robot is equal to 90°, the robot begins to enter the virtual rectangular frame. An included angle formed by an end point of the virtual rectangular frame with respect to the current traveling direction of the robot is a deflection angle formed by a connecting line between the end point and the center of the robot body relative to the current traveling direction of the robot. In the example, according to a relative angular position relation between different end points of the virtual rectangular frame and a real-time pose of the robot is used to determine that the robot travels to the interior of the virtual rectangular frame. When the robot is close enough to the target obstacle, the virtual rectangular frame surrounding the target obstacle is used to trigger a signal that the robot detects the obstacle, but the behavior of the robot is not limited by setting a safety threshold.

Specifically, after the robot is at the interior the virtual rectangular frame (including being located on a rectangular edge of the virtual rectangular frame), the step of determining that the current traveling direction of the robot tends to collide with the target obstacle includes: whether an included angle formed by a connecting line between the center of the robot body and the center of the virtual rectangular frame and the current traveling direction of the robot is an acute angle is determined, in a case that yes, the current traveling direction of the robot tends to collide with the target obstacle is determined, and in a case that not, the current traveling direction of the robot does not tend to collide with the target obstacle is determined. In the example, according to a relative angle relation between the center of the virtual rectangular frame and a real-time pose of the robot is used to determine whether the movement trend of the robot located at the interior of the virtual rectangular frame will collide with the target obstacle. No safety doorsill are set to limit the movement of the robot, and the use of a collision sensor to detect early warning under the condition of approaching the target obstacle is avoided. Moreover, after it is determined that the movement trend of the robot will not collide with the target obstacle, it is also deduced that the movement trend of the robot is deviated from the target obstacle.

The example of the disclosure further discloses a cleaning robot. The cleaning robot includes an infrared sensor, a cleaning device, a TOF camera and a processing unit, and the TOF camera is mounted in front of the cleaning robot at a preset inclination angle, such that a detection an angle of view of the TOF camera covers a preset traveling plane in front of the cleaning robot; and the infrared sensor is mounted on a side of the cleaning robot for executing the infrared obstacle avoidance mode of above example. The cleaning device is used for executing a cleaning action in a controlled obstacle avoidance mode. The processing unit is electrically connected to the TOF camera and the cleaning device respectively to be used for executing the method for controlling of obstacle avoidance according to the classification of the obstacle based on the TOF camera in above example. In the example, the cleaning robot is provided with a 3d-tof photographing device that simultaneously photographs a depth image and a luminance image. The top or side of the cleaning robot is provided with a photographing device including an infrared photographing device and array laser measurement. Reference can be made to Chinese patent CN 111624997 A for the schematic structural diagram of a hardware structure of the cleaning robot. The 3d-tof photographing device is a 3d-ToF sensor that obtains a depth image and an infrared image according to time of flight of infrared light, and the 3d-ToF sensor includes an infrared light emitter and an infrared light receiver. The infrared light receiver generates a grayscale image and the depth image according to infrared light reflected by surfaces of the obstacle. The cleaning robot disclosed in the example integrates many types of obstacle identification function algorithms, and is suitable for cleaning operations in an indoor actual activity environment. Too many image feature points are executed and fitting classification training is over large, production cost is reduced, and an operation load of the robot for identifying an obstacle is lightened.

Obviously, above examples are merely instances given for clear illustration, and are not intended to limit embodiments. A person of ordinary skill in the pertained field can make modifications or variations in other forms on the basis of above description. There are no need and no way to exhaust all the embodiments. Obvious modifications or variations derived from the embodiments shall still fall within the protection scope of the disclosure.

What is claimed is:

1. A method for controlling of obstacle avoidance according to a classification of an obstacle based on a time-of-flight (TOF) camera, comprising:
calculating and obtaining a longitudinal height of a target obstacle by combining depth information of the target obstacle collected by a TOF camera and intrinsic parameters and extrinsic parameters of the TOF camera, and identifying and classifying the target obstacle into a wall-type obstacle, a toy-type obstacle, a doorsill-type obstacle, a sofa-type obstacle or an electric-wire-type obstacle on a basis of a data stability statistical algorithm; and
deciding on a deceleration and obstacle avoidance mode or a deceleration and obstacle bypassing mode of a robot according to a classification result, the longitudinal height of the target obstacle of a corresponding type and a trigger situation of a collision warning signal such that the robot preferentially enter an infrared obstacle avoidance mode in a trigger state of the collision warning signal;
wherein an executive body of the method for controlling of obstacle avoidance according to the classification of the obstacle is the robot provided with the TOF camera and an infrared sensor at a front end of a robot body; and
the robot in the infrared obstacle avoidance mode avoids an obstacle detected in a current traveling direction on a basis of detection information of the infrared sensor.

2. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal comprises:
controlling, under a condition that the robot currently executes [symbol] -shaped traveling or global edge-following traveling, the robot to travel in a decelerating manner in the current traveling direction after the target obstacle is classified into the toy-type obstacle and the longitudinal height of the target obstacle which is obtained by calculating is greater than a first preset toy height, simultaneously determining whether the robot triggers the collision warning signal, in a case that yes, stopping traveling in the decelerating manner in the current traveling direction, and avoiding the obstacle detected in the current traveling direction on the basis of the detection information of the infrared sensor, and in a case that not, avoiding the obstacle detected in the current traveling direction on the basis of the detection information of the infrared sensor; wherein
in a process that the robot executes the [symbol] -shaped traveling or the global edge-following traveling, the infrared sensor on the robot detects the obstacle in real time.

3. The method for controlling of obstacle avoidance according to the classification of the obstacle based on the TOF camera as claimed in claim 2, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
controlling, under a condition that the robot currently executes the [symbol] -shaped traveling, the robot to travel in the decelerating manner after the target obstacle is classified into the toy-type obstacle and the longitudinal height of the target obstacle which is obtained by calculating is less than the first preset toy height, simultaneously determining whether the robot triggers the collision warning signal, in a case that yes, stopping traveling in the decelerating manner, and avoiding the obstacle detected in the current traveling direction on the basis of the detection information of the infrared sensor, and in a case that not, when a depth distance between the robot and the target obstacle equals a first toy safety distance, controlling the robot to rotate by 90° in a first preset clockwise direction, move forward by a first preset distance, rotate by 90° in the first preset clockwise direction, and move forward, so as to implement right-angle turning; and
controlling, under a condition that the robot currently executes the global edge-following traveling, the robot to travel in the decelerating manner after the target obstacle is classified into the toy-type obstacle and the longitudinal height of the target obstacle which is obtained by calculating is less than or equal to the first preset toy height, simultaneously determining whether the robot triggers the collision warning signal, in a case that yes, stopping traveling in the decelerating manner, and avoiding the obstacle detected in the current traveling direction on the basis of the detection information of the infrared sensor, and in a case that not, when the depth distance between the robot and the target obstacle equals a second toy safety distance, controlling the robot to rotate by 90° in a second preset clockwise direction, move forward by a second preset distance, rotate by 90° in a reverse direction of the second preset clockwise direction, and move forward by a third preset distance, detecting whether other obstacles are present on an original global edge-following path by rotating a first observation angle, in a case that yes, bypassing a detected obstacle by first preset moving radian in an obstacle-bypassing traveling mode, and returning to the original global edge-following path, and in a case that not, bypassing the target obstacle by second preset moving radian, and returning to the original global edge-following path; wherein
the first preset distance and the second preset distance are both related to a contour width of the target obstacle collected by the TOF camera, and the contour width equals a horizontal distance between a leftmost side and a rightmost side of the target obstacle in a field-of-view area of the TOF camera; and
the first toy safety distance is related to the depth information measured in a process that the robot executes the [symbol] -shaped traveling; and the second toy safety distance is related to the depth information measured in a process that the robot executes the global edge-following traveling.

4. The method for controlling of obstacle avoidance according to the classification of the obstacle based on the TOF camera as claimed in claim 3, wherein the first preset toy height is set as 65 mm; and the toy-type obstacle comprise an island-type obstacle.

5. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
controlling, under a condition that the robot currently executes [symbol] -shaped traveling or global edge-following traveling, the robot to travel in a decelerating manner to pass over a doorsill after the target obstacle is classified into the doorsill-type obstacle; and the doorsill-type obstacle comprises the obstacle for the robot to pass over.

6. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
controlling, under a condition that the robot currently executes [symbol] -shaped traveling, the robot to keep executing an original [symbol] -shaped traveling after the target obstacle is classified into the wall-type obstacle, and simultaneously determining whether the robot triggers the collision warning signal, in a case that yes, stopping executing the [symbol] -shaped traveling, and avoiding the obstacle detected in the current traveling direction on the basis of the detection information of the infrared sensor, and in a case that not, avoiding the obstacle detected in the current traveling direction on the basis of the detection information of the infrared sensor; and
controlling, under a condition that the robot currently executes global edge-following traveling, the robot to keep executing the original edge-following traveling, and simultaneously determining whether the robot triggers the collision warning signal, in a case that yes, stopping executing the edge-following traveling, and avoiding the obstacle detected in the current traveling direction on the basis of the detection information of the infrared sensor, and in a case that not, keeping executing the original edge-following traveling.

7. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
under a condition that a traveling mode currently executed by the robot is [symbol] -shaped traveling, deceleration and obstacle avoidance modes as follows:
controlling, under a condition that the target obstacle is classified into the sofa-type obstacle and the longitudinal height of the target obstacle which is obtained by calculating is less than or equal to a first preset sofa height, the robot to keep executing the original [symbol] -shaped traveling, simultaneously determining whether the robot triggers the collision warning signal, in a case that yes, stopping executing an original [symbol] -shaped traveling, and avoiding the obstacle detected in the current traveling direction on the basis of the detection information of the infrared sensor, and in a case that not, avoiding the obstacle detected in the current traveling direction on the basis of the detection information of the infrared sensor;
controlling, under a condition that the target obstacle is classified into the sofa-type obstacle and the longitudinal height of the target obstacle which is obtained by calculating is greater than the first preset sofa height and less than or equal to a second preset sofa height, the robot to travel in a decelerating manner in the current traveling direction, simultaneously determining whether the robot triggers the collision warning signal, in a case that yes, stopping traveling in the decelerating manner in the current traveling direction, and avoiding the obstacle detected in the current traveling direction on the basis of the detection information of the infrared sensor, and in a case that not, avoiding the obstacle detected in the current traveling direction on the basis of the detection information of the infrared sensor; and controlling, under a condition that the target obstacle is classified into the sofa-type obstacle and the longitudinal height of the target obstacle which is obtained by is greater than the second preset sofa height, the robot to keep executing the original [symbol] -shaped traveling to enter a bottom of the sofa-type obstacle, simultaneously determining whether the robot triggers the collision warning signal, in a case that yes, stopping executing the [symbol] -shaped traveling, and avoiding other obstacles detected in the current traveling direction on the basis of the detection information of the infrared sensor, and in a case that not, keeping executing the original [symbol] -shaped traveling; wherein
the second preset sofa height is greater than the robot body height of the robot; the second preset sofa height is greater than the first preset sofa height; and the other obstacles are obstacles other than the sofa-type obstacle; and
the sofa-type obstacle comprises furniture for the robot to pass through.

8. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
under a condition that a traveling mode currently executed by the robot is global edge-following traveling, deceleration and obstacle avoidance modes as follows:
controlling, under a condition that the target obstacle is classified into the sofa-type obstacle and the longitudinal height of the target obstacle which is obtained by calculating is less than or equal to a third preset sofa height, the robot to travel in a decelerating manner along a contour of the target obstacle, such that the robot does not get stuck by the target obstacle when colliding with the target obstacle; and
controlling, under a condition that the target obstacle is classified into the sofa-type obstacle and the longitudinal height of the target obstacle which is obtained by calculating is greater than the third preset sofa height, the robot to travel in the decelerating manner along an edge, and simultaneously controlling the robot to determine occupied position area of the target obstacle through collision, such that the robot does not get stuck by the target obstacle when colliding with the target obstacle, wherein the third preset sofa height is greater than a first preset sofa height, and a second preset sofa height is greater than the third preset sofa height.

9. The method for controlling of obstacle avoidance according to the classification of the obstacle based on the TOF camera as claimed in claim 8, wherein the third preset sofa height is set as 110 mm, the second preset sofa height is set as 90 mm, and the first preset sofa height is set as 50 mm; and the sofa-type obstacle comprises a furniture obstacle for the robot to pass through.

10. The method for controlling of obstacle avoidance according to the classification of the obstacle based on the TOF camera as claimed in claim 1, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
controlling, under a condition that the robot currently executes [symbol] -shaped traveling, the robot to travel in a decelerating manner after the target obstacle is classified into the electric-wire-type obstacle and the longitudinal height of the target obstacle which is obtained by calculating is greater than a first preset electric wire height, simultaneously determining whether the robot triggers the collision warning signal, in a case that yes, stopping traveling in the decelerating manner, and avoiding the obstacle detected in the current traveling direction on the basis of the detection information of the infrared sensor, and in a case that not, when a depth distance between the robot and the target obstacle is a first electric wire safety distance, controlling the robot to rotate by 90° in a first preset clockwise direction, move forward by a fourth preset distance, rotate by 90° in the first preset clockwise direction, and move forward, so as to implement right-angle turning; and
controlling, under a condition that the robot currently executes global edge-following traveling, the robot to travel in the decelerating manner after the target obstacle is classified into the electric-wire-type obstacle and the longitudinal height of the target obstacle which is obtained by calculating is greater than the first preset electric wire height, simultaneously determining whether the robot triggers the collision warning signal, in a case that yes, stopping traveling in the decelerating manner, and avoiding the obstacle detected in a current edge-following direction on the basis of the detection information of the infrared sensor, and in a case that not, when the depth distance between the robot and the target obstacle is a second electric wire safety distance, controlling the robot to rotate by 90° in a second preset clockwise direction, move forward by a fifth preset distance, rotate by 90° in a reverse direction of the second preset clockwise direction, and move forward by a sixth preset distance, detecting whether other obstacles are present on an original global edge-following traveling path by rotating by a second observation angle, in a case that yes, bypassing a detected obstacle by third preset moving radian in an obstacle-bypassing traveling mode, and returning to the original global edge-following traveling path, and in a case that not, bypassing the target obstacle by fourth preset moving radian, and returning to the original global edge-following traveling path; wherein
in a process that the robot executes the [symbol] -shaped traveling and the global edge-following traveling, the infrared sensor on the robot detects the obstacle in real time;
the fourth preset distance and the fifth preset distance are both related to a contour width of the target obstacle collected by the TOF camera; and the contour width equals a horizontal distance between a leftmost side and a rightmost side of the target obstacle in a field-of-view area of the TOF camera; and
the first electric wire safety distance is related to the depth information measured in a process that the robot executes the [symbol] -shaped traveling; and the second electric wire safety distance is related to the depth information measured in a process that the robot executes the global edge-following traveling.

11. The method for controlling of obstacle avoidance according to the classification of the obstacle based on the TOF camera as claimed in claim 10, wherein the first preset electric wire height is set as 5 mm, and the electric-wire-type obstacle comprises entanglements.

12. The method for controlling of obstacle avoidance according to the classification of the obstacle based on the TOF camera as claimed in claim 1, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

13. The method for controlling of obstacle avoidance according to the classification of the obstacle based on the TOF camera as claimed in claim 7, wherein deciding on the deceleration and obstacle avoidance mode or the deceleration and obstacle bypassing mode of the robot according to the classification result, the longitudinal height of the target obstacle of the corresponding type and the trigger situation of the collision warning signal further comprises:
under a condition that a traveling mode currently executed by the robot is global edge-following traveling, deceleration and obstacle avoidance modes as follows:
controlling, under a condition that the target obstacle is classified into the sofa-type obstacle and the longitudinal height of the target obstacle which is obtained by calculating is less than or equal to a third preset sofa height, the robot to travel in the decelerating manner along a contour of the target obstacle, such that the robot does not get stuck by the target obstacle when colliding with the target obstacle; and
controlling, under a condition that the target obstacle is classified into the sofa-type obstacle and the longitudinal height of the target obstacle which is obtained by calculating is greater than the third preset sofa height, the robot to travel in the decelerating manner along an edge, and simultaneously controlling the robot to determine occupied position area of the target obstacle through collision, such that the robot does not get stuck by the target obstacle when colliding with the target obstacle, wherein the third preset sofa height is greater than the first preset sofa height, and the second preset sofa height is greater than the third preset sofa height.

14. The method for controlling of obstacle avoidance according to the classification of the obstacle based on the TOF camera as claimed in claim 2, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

15. The method for controlling of obstacle avoidance according to the classification of the obstacle based on the TOF camera as claimed in claim 3, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

16. The method for controlling of obstacle avoidance according to the classification of the obstacle based on the TOF camera as claimed in claim 4, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

17. The method for controlling of obstacle avoidance according to the classification of the obstacle based on the TOF camera as claimed in claim 5, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

18. The method for controlling of obstacle avoidance according to the classification of the obstacle based on the TOF camera as claimed in claim 6, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

19. The method for controlling of obstacle avoidance according to the classification of the obstacle based on the TOF camera as claimed in claim 7, wherein the data stability statistical algorithm is to classify the depth information and longitudinal height of the target obstacle on the basis of filtration and statistical algorithms, so as to establish a three-dimensional contour of the target obstacle, and classify the target obstacle into a wall model, a toy model, a doorsill model, a sofa model or an electric wire model.

20. A cleaning robot, comprising:
an infrared sensor, a cleaning device, a time-of-flight (TOF) camera and a processing unit,
wherein, the TOF camera is mounted in front of the cleaning robot at a preset inclination angle, the infrared sensor is mounted on a side of the cleaning robot for executing an infrared obstacle avoidance mode, the cleaning device is used for executing a cleaning action in a controlled obstacle avoidance mode, the processing unit is electrically connected to the TOF camera and the cleaning device respectively, and used for executing the method for controlling of obstacle avoidance according to the classification of the obstacle based on the TOF camera as claimed in claim 1.
